(19) United States
(12) Patent Application Publication
(10) Pub. No.: US 2011/0158428 A1
(43) Pub. Date: Jun. 30, 2011

(54) SOUND DISTORTION SUPPRESSION CONTROL METHOD AND ACOUSTIC CONTROL APPARATUS USING THE METHOD

(76) Inventors: Kenji HASHIZUME, Kobe-shi (JP); Masato FUJI, Osaki-shi (JP)

(21) Appl. No.: 12/976,044

(22) Filed: Dec. 22, 2010

(30) Foreign Application Priority Data
Dec. 25, 2009 (JP) 2009-294743

(51) Int. Cl. H04B 15/00

(52) U.S. Cl. 381/94.1

(57) ABSTRACT

A sound distortion suppression control method not causing sound distortion even if the volume of an amplifier is increased to nearly its maximum value when the user adjusts bass and treble to obtain desired tone. Sound to be output is specified by a volume setting value, a bass setting value and a treble setting value, and these values are temporarily stored in a memory section. Furthermore, a maximum allowable bass value and a maximum allowable treble value are respectively stored in the memory section in advance. In the case that the bass setting value and the treble setting value become larger than the maximum allowable bass value and the maximum allowable treble value, respectively, the bass setting value and the treble setting value are changed to a value not more than the maximum allowable bass value and a value not more than the maximum allowable treble value, respectively.

### BACKGROUND OF THE INVENTION

1. Field of the Invention

The present invention relates to a sound distortion suppression control method in an acoustic apparatus mounted on a vehicle, such as a motorcycle, and to an acoustic control apparatus using the method.

2. Description of the Prior Art

Patent document 1 discloses an audio system capable of automatically adjusting the volume setting of an acoustic apparatus mounted on a vehicle, such as a motorcycle, depending on the traveling speed of the vehicle.

In addition, Patent document 2 discloses a loudness adjustment circuit wherein when the control terminal voltages corresponding to volume, bass and treble are detected and when the control terminal voltages corresponding to the bass and treble are not less than certain setting values and in the case that the control terminal voltages corresponding to the volume is set to nearly its maximum value, the control terminal voltages corresponding to the bass and treble are lowered.

### PRIOR ART DOCUMENT

### Patent Document

Patent document 1: Japanese Patent Application Laid-open Publication No. 2002-362241
Patent document 2: Japanese Patent Application Laid-open Publication No. Hei 08-256032

Patent document 1 relates to an audio system equipped with a so-called auto volume control function for automatically adjusting the volume setting of an acoustic apparatus depending on the speed of a vehicle. If the volume of an amplifier is increased to nearly its maximum value in a state in which tone is set so as to be well-modulated by emphasizing bass and treble, the volume is saturated due to the nature of the amplifier. As a result, there occurs a problem in which output sound is distorted and uncomfortable acoustic feeling is caused.

Furthermore, in the loudness adjustment circuit disclosed in Patent document 2, a detection circuit for detecting the control terminal voltages corresponding to the volume, bass and treble is additionally required. As a result, there occurs a problem in which the acoustic circuit thereof becomes complicated as a whole and cost is increased.

### SUMMARY OF THE INVENTION

Accordingly, the technical problem to be solved according to the present invention is to provide a sound distortion suppression control method not causing sound distortion even if the volume of an amplifier is increased to nearly its maximum value when the user adjusts bass and treble to obtain desired tone, and to provide an acoustic control apparatus using the method at a moderate price.

In order to solve the above-mentioned technical problem, the present invention provides a sound distortion suppression control method described below and an acoustic control apparatus using the method.

More specifically, a sound distortion suppression control method according to claim 1 of the present invention is a sound distortion suppression control method for suppressing the distortion of sound to be output from an acoustic apparatus mounted on a vehicle, including:

a step in which sound to be output is specified by a volume setting value, a bass setting value and a treble setting value, and the volume setting value, the bass setting value and the treble setting value are stored temporarily and respectively in a memory section,

a step in which a maximum allowable bass value and a maximum allowable treble value respectively corresponding to the volume setting value and used to suppress sound distortion are respectively stored in the memory section in advance, a step in which in the case that the bass setting value and the treble setting value corresponding to the specified volume setting value become larger than the maximum allowable bass value and the maximum allowable treble value, respectively, the bass setting value and the treble setting value are changed to a value not more than the maximum allowable bass value and a value not more than the maximum allowable treble value, respectively, and

a step in which sound is output on the basis of the specified volume setting value, the changed bass setting value and the changed treble setting value.

A sound distortion suppression control method according to claim 2 of the present invention is characterized in that the volume setting value is controlled automatically depending on the traveling speed of the vehicle.

A sound distortion suppression control method according to claim 3 of the present invention is characterized in that the sound distortion of sound to be output is suppressed to a distortion ratio of not more than 1%.

An acoustic control apparatus according to claim 4 of the present invention is an acoustic control apparatus for suppressing the sound distortion of sound to be output from an acoustic apparatus mounted on a vehicle, including:

a memory section for temporarily and respectively storing a volume setting value, a bass setting value and a treble setting value for specifying sound to be output and for respectively storing in advance a maximum allowable bass value and a maximum allowable treble value respectively corresponding to the volume setting value and used to suppress sound distortion, and a control section for changing the bass setting value and the treble setting value to a value not more than the maximum allowable bass value and a value not more than the maximum allowable treble value, respectively, in the case that the bass setting value and the treble setting value respectively corresponding to the specified volume setting value become larger than the maximum allowable bass value and the maximum allowable treble value, respectively, wherein

sound is output on the basis of the specified volume setting value, the changed bass setting value and the changed treble setting value.

The acoustic control apparatus according to claim 5 of the present invention is characterized in that the volume setting value is adjusted automatically depending on the traveling speed of the vehicle.

The acoustic control apparatus according to claim 6 of the present invention is characterized in that the sound distortion of sound to be output is suppressed to a distortion ratio of not more than 1%.

Sound is made louder automatically or manually by the user as the traveling speed of the vehicle is increased so that the sound being output during the traveling of the vehicle can be heard easily. The sound made louder corresponds to any ones of the volume setting value, the bass setting value and the treble setting value stored in the memory section.

In the present invention according to claim 1, in the case that the bass setting value and the treble setting value corresponding to the volume setting values for specifying the sound made louder are set so as to be larger than the maximum allowable bass value and the maximum allowable treble value stored in the memory section, respectively, the bass setting value and the treble setting value are forcibly changed to a value not more than the maximum allowable bass value and a value not more than the maximum allowable treble value, respectively, at which sound distortion is suppressed. In other words, in the present invention, the changes relating to the bass setting value and the treble setting value for specifying the tone of the sound to be output are carried out through so-called software-based processing. Hence, in the case that the sound is set so as to have tone in which the bass or the treble is emphasized and sound distortion tends to occur, when the volume to be output is increased, the bass setting value and the treble setting value are only changed through software-based processing to the values at which sound distortion is suppressed. Hence, the present invention has an effect capable of attaining sound distortion suppression control at low cost.

In the present invention according to claim 2, even in the case that the so-called auto volume control function for automatically adjusting the volume setting value depending on the traveling speed of the vehicle is executed, sound distortion suppression control is carried out. Hence, no adjustment operation is required during the traveling of the vehicle, whereby the present invention has an effect capable of ensuring safety driving.

The present invention according to claim 3 has an effect of not causing uncomfortable acoustic feeling.

Also in the present invention according to claim 4, as in the invention according to claim 1 described above, in the case that the sound is set so as to have tone in which the bass or the treble is emphasized and sound distortion tends to occur, when the volume to be output is increased, the bass setting value and the treble setting value are only changed through software-based processing to the values at which sound distortion is suppressed. Hence, the present invention has an effect capable of attaining sound distortion suppression control at low cost.

Also in the present invention according to claim 5, as in the invention according to claim 2 described above, no adjustment operation is required during the traveling of the vehicle, whereby the present invention has an effect capable of ensuring safety driving.

Also in the present invention according to claim 6, as in the invention according to claim 4 described above, the present invention has an effect of not causing uncomfortable acoustic feeling.

### BRIEF DESCRIPTION OF THE DRAWINGS

FIG. 1 is a perspective view showing a motorcycle equipped with an acoustic control apparatus according to an embodiment of the present invention, as seen from the rear left side;

FIG. 2 is a block diagram showing the acoustic control apparatus according to the embodiment of the present invention;

FIG. 3 is a front view showing examples of the input operation section and the display section of the acoustic control apparatus shown in FIG. 2; and

FIG. 4 is a flowchart showing the operation of the acoustic control apparatus shown in FIG. 2.

### DETAILED DESCRIPTION OF THE PREFERRED EMBODIMENTS

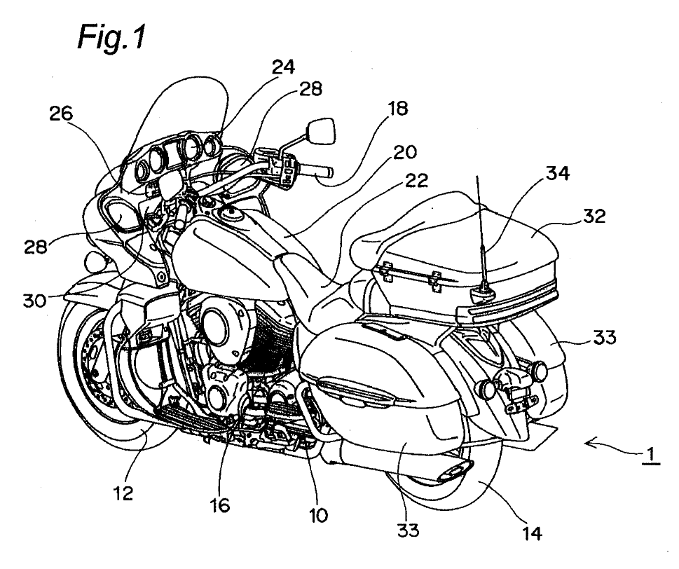

A sound distortion suppression control method and an acoustic control apparatus using the method according to an embodiment of the present invention will be described below in detail referring to FIGS. 1 to 4.

FIG. 1 is a perspective view showing a motorcycle 1 as an example of a vehicle, as seen from the rear left side. The front, rear, left and right directions in the present specification are based on the front, rear, left and right directions of the vehicle.

FIG. 1 shows the motorcycle 1, such as a motorbike or a motor scooter. A front wheel 12 and a rear wheel 14 are rotatably supported on a vehicle body frame 10. An engine 16 is mounted at the central section of the vehicle body frame 10. Above the engine 16, a fuel tank 20 is installed on the front side and a seat 22 is installed on the rear side.

A handle 18 is installed so as to be turnable with respect to the front wheel 12, and the handle 18 is equipped with rear-view mirrors, a switch case, a brake lever, etc. A meter panel 24 for indicating vehicle information, such as vehicle speed, engine speed, fuel quantity and water temperature, is installed on a front panel 30 located ahead of the handle 18. An acoustic apparatus 26 is built in the central section of the front panel 30. A pair of left and right speakers 28 is disposed on both sides of the acoustic apparatus 26.

An upper storage box 32 and left and right storage boxes 33 are installed on the vehicle body frame 10 located above the rear wheel 14. In addition, an antenna 34 connected to the receiver of the acoustic apparatus 26 described later is set up on the upper storage box 32.

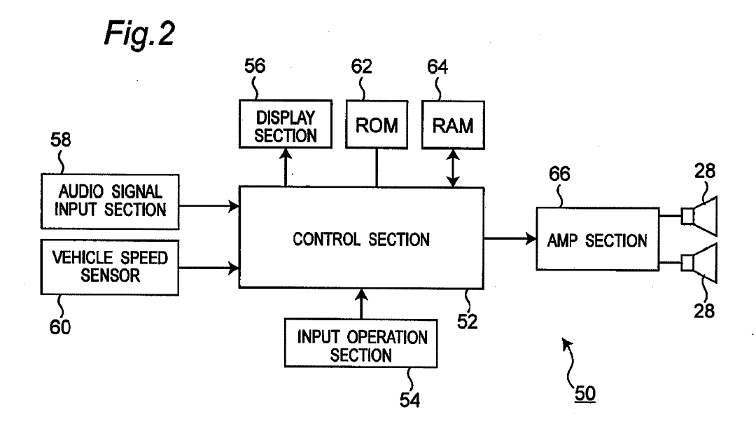

As shown in FIG. 2, the box-like acoustic apparatus 26 is equipped with an acoustic control apparatus 50 including a control section 52 formed of a central processing unit, i.e., a CPU; an amp section 66 for amplifying an audio signal; a read-only memory, i.e., a ROM 62; a randomly writable memory, i.e., a RAM (random access memory) 64; the receiver for receiving AM radio signals, FM radio signals, satellite radio signals, etc.; and an audio signal input section 58 for receiving audio signals output from the external input jack (AUX) of the receiver or a portable acoustic apparatus having a compact size.

In the acoustic control apparatus 50, the amp section 66, the ROM 62, the RAM 64 and the audio signal input section 58 are respectively connected to the control section 52 electrically. Furthermore, in the acoustic control apparatus 50, a power supply voltage from a vehicle battery, not shown, is supplied, and predetermined power supply voltages are supplied to the necessary components thereof as appropriate. Although the memory section (memory) thereof is formed of the ROM (read-only memory) 62 and the RAM (random access memory) 64, the present invention is not limited to this configuration.

The control section 52 concentratedly controls various operations in the acoustic control apparatus 50 according to various processing programs and tables stored in the ROM 62 in advance. Stored in the ROM 62 in advance are programs to be executed by the control section 52; default values (default volume value, default automatic volume control value and default bass value and default treble value) relating to default output sound; a table for calculating traveling speed of the vehicle on the basis of output data from a vehicle speed sensor 60; a volume setting value table for changing the volume setting value depending on the traveling speed of the vehicle on the basis of the setting mode of automatic volume control (AUTO VOLUME CONTROL: AVC); and a table of predetermined data values (a maximum allowable bass value and a maximum allowable treble value) corresponding to each volume setting value and used to suppress sound distortion.

TABLE 1 exemplifies the maximum allowable bass value and the maximum allowable treble value corresponding to each volume setting value. However, the present invention is not limited to the values exemplified in TABLE 1. Each of the maximum allowable bass values and the maximum allowable treble values listed in TABLE 1 is a value that is used when the sound distortion of sound to be output is suppressed to a distortion rate of not more than 1%.

TABLE 1

| Volume setting | Maximum allowable | Maximum allowable |
|---|---|---|
| value | bass value | treble value |
| (Level) | (Level) | (Level) |
| 0 | +7 | +7 |
| 1 | +7 | +7 |
| 2 | +7 | +7 |
| 3 | +7 | +7 |
| 4 | +7 | +7 |
| 5 | +7 | +7 |
| 6 | +7 | +7 |
| 7 | +7 | +7 |
| 8 | +7 | +7 |
| 9 | +6 | +7 |
| 10 | +6 | +7 |
| 11 | +5 | +7 |
| 12 | +5 | +7 |
| 13 | +4 | +7 |
| 14 | +3 | +7 |
| 15 | +2 | +7 |
| 16 | +2 | +7 |
| 17 | +2 | +7 |
| 18 | +2 | +6 |
| 19 | +2 | +6 |
| 20 | +1 | +5 |
| 21 | +1 | +5 |
| 22 | +1 | +4 |
| 23 | +1 | +4 |
| 24 | +1 | +3 |
| 25 | +1 | +3 |
| 26 | +1 | +2 |
| 27 | +1 | +2 |
| 28 | +1 | +1 |
| 29 | +0 | +0 |
| 30 | +0 | +0 |

Furthermore, stored temporarily in the RAM 64 are various values (the vehicle speed data value obtained from the vehicle speed sensor 60, and the volume setting value, the bass setting value and the treble setting value for specifying sound to be output) relating to sound to be used when programs are executed by the control section 52.

The pair of left and right speakers 28 is electrically connected to the output side of the amp section 66 and used to output sound. The practical maximum output of the amp section 66 is 20 W or more, for example. Preferably, the vehicle speed sensor 60 is electrically connected to the control section 52 as optional equipment. The vehicle speed sensor 60 generates a pulse signal corresponding to the number of revolutions of the wheels 12 and 14, and the traveling speed of the motorcycle 1 is calculated on the basis of the pulse signal.

The vehicle speed signal output from the vehicle speed sensor 60 is utilized for the auto volume control (AVC), i.e., automatic volume control function (AVC function), and used to automatically adjust the volume setting value of the acoustic apparatus 26 depending on the traveling speed of the vehicle. The automatic volume control function is herein defined as a function for automatically increasing the preset volume setting value as the traveling speed of the vehicle rises and for automatically decreasing the preset volume setting value as the traveling speed of the vehicle lowers in order to solve the problem that the traveling noise of the vehicle increases during high-speed traveling and it becomes difficult to hear sound.

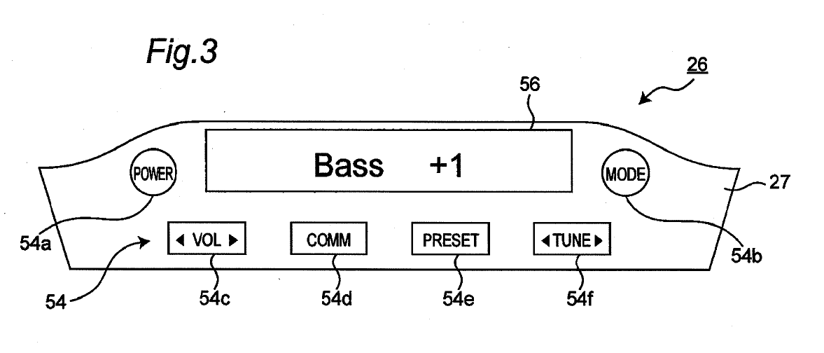

As shown in FIG. 3, the box-like acoustic apparatus 26 is equipped with a panel body 27 disposed so as to be on approximately the same level with the front panel 30. A horizontally long display section 56 formed of various display devices, such as liquid crystal panels and organic EL panels, for displaying various kinds of acoustic information and an input operation section 54 disposed so as to enclose the display section 56 is provided on the surface of the panel body 27.

The input operation section 54 of the acoustic apparatus 26 is equipped with a power button (POWER) 54a and a mode switching button (MODE) 54b on the upper side thereof starting from the left and is also equipped with a volume operation button (VOL) 54c, a communication button (COMM) 54d, a preset button (PRESET) 54e and a tuner button (TUNE) 54f on the lower side thereof starting from the left, as shown in FIG. 3.

The volume setting value desired by the user is input by operating the volume operation button (VOL) 54c of the input operation section 54, and the volume setting value is stored in the RAM 64. The volume setting value is set in the range of level 0 to level 30, for example.

The mode switching mode can be entered by pressing the mode switching button (MODE) 54b of the input operation section 54 slightly longer (in other words, by performing a long time pressing operation). Immediately after the long time pressing operation, a display for adjusting the tone in the bass range (BASS), for example, is displayed on the display section 56. Furthermore, the bass setting value desired by the user is input by operating the volume operation button (VOL) 54c in the setting of the bass range (BASS), and the bass setting value is temporarily stored in the RAM 64. The bass setting value is set in the range of level −7 to level +7, for example.

Next, the treble range (TREBLE) setting mode can be entered by pressing the mode switching button (MODE) 54b of the input operation section 54 slightly shorter (in other words, by performing a short time pressing operation). Similarly, the treble setting value desired by the user is input by operating the volume operation button (VOL) 54c in the setting of the treble range (TREBLE), and the treble setting value is temporarily stored in the RAM 64. The treble setting value is set in the range of level −7 to level +7, for example.

The setting mode is switched sequentially from a fade (FADE) setting mode to a speaker (SPKRS) setting mode, to an automatic volume control (AVC) setting mode and to an automatic tone control (AUTO TONE CONTROL) setting mode by further pressing the mode switching button (MODE) 54b of the input operation section 54 slightly shorter (in other words, by performing a short time pressing operation).

Any one of values 0 to 5, for example, is set by operating the volume operation button 54c in the automatic volume control (AVC) setting mode. In the case that the setting value of the automatic volume control (AVC) is 0, the setting value indicates that this function is in its inoperable state (OFF). Hence, the volume setting value set by the user is maintained, and changes relating to the volume setting value are not carried out.

In the case that the setting value of the automatic volume control (AVC) is in the range of 1 to 5, for example, the setting value indicates that this function is in its operable state (ON). In the case that the setting value of the automatic volume control (AVC) is in the range of 1 to 5, the preset volume setting value is increased automatically as the traveling speed of the vehicle rises, and the preset volume setting value is decreased automatically as the traveling speed of the vehicle lowers. As the setting value of the automatic volume control (AVC) increases from 1 to 5, the period during which the volume reaches the maximum volume becomes shorter, and the inclination to increase the volume becomes steeper. For example, in the case that the volume setting value is level 15 and that the setting value of the automatic volume control (AVC) is 3, the maximum volume is reached when the traveling speed of the vehicle becomes 120 km/hour.

AUTO or NORMAL is set by operating the volume operation button (VOL) 54c in the automatic tone control (AUTO TONE CONTROL) setting mode. When AUTO is set in the automatic tone control (AUTO TONE CONTROL) setting mode, in the case that the bass setting value and the treble setting value for specifying the increased sound have been set so as to be larger than the maximum allowable bass value and the maximum allowable treble value stored in the memory section (ROM 62), the bass setting value and the treble setting value are changed to a value not more than the maximum allowable bass value and a value not more than the maximum allowable treble value, respectively, at which sound distortion is suppressed. When NORMAL is set in the automatic tone control (AUTO TONE CONTROL) setting mode. The bass setting value and the treble setting value set by the user are maintained, and changes relating to the bass setting value and the treble setting value are not carried out.

In the present invention, various values relating to the volume, bass and treble are described by using the range from level 0 to level 30, the range from level −7 to level +7, and the range from level −7 to level +7, respectively. In the case that the level increases by 1, the output increases by 2 decibels (dB). Conversely, in the case that the level decreases by 1, the output decreases by 2 decibels (dB).

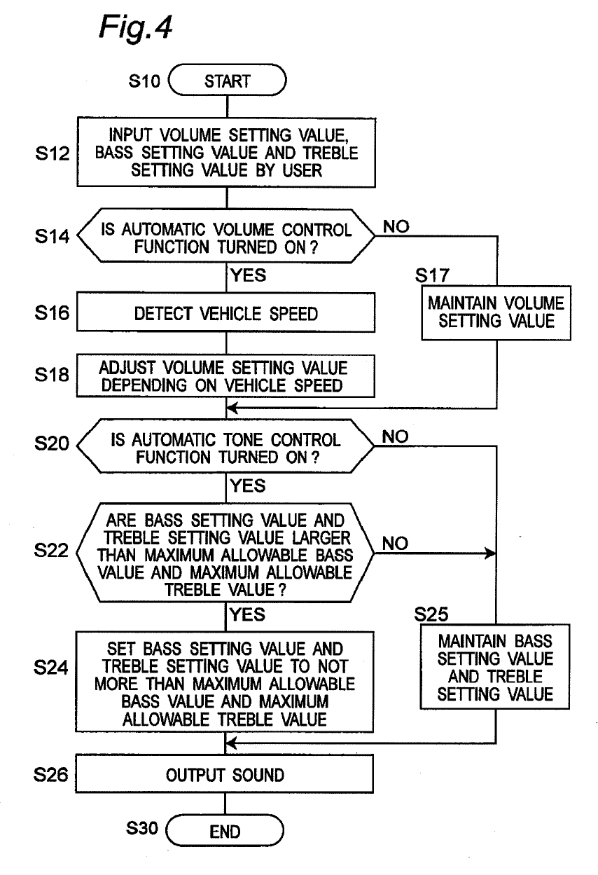

Next, the sound distortion suppression control method according to the embodiment of the present invention will be described referring to FIG. 4.

At step S10, the sound distortion suppression control method according to the embodiment of the present invention starts. When the power button (POWER) 54a of the input operation section 54 is pressed, the default values (default volume value, default automatic volume control value, default bass value and default treble value) relating to default output sound are read from the ROM 62, whereby the sound having the default volume and tone can be output from the speakers 28. As examples of the default values, the default volume value is level 5, the default automatic volume control value is 1, the default bass value is level +0, and the default treble value is level +0.

At step S12, the volume setting value, the bass setting value and the treble setting value for specifying the sound desired by the user are respectively input and temporarily stored in the RAM 64. In other words, the volume setting value for specifying the sound desired by the user is input by operating the volume operation button (VOL) 54c. In addition, the bass setting value and the treble setting value for specifying the sound desired by the user are respectively input by appropriately switching the mode switching button (MODE) 54b. Furthermore, the input of the setting value relating to the automatic volume control (AVC) and the setting relating to the automatic tone control function, desired by the user, are carried out.

At step S14, a judgment is made as to whether the automatic volume control (AVC) function is turned ON (in other words, any one of values 1 to 5 has been input). In the case that the automatic volume control (AVC) function is turned ON, the procedure advances to step S16. Furthermore, in the case that the automatic volume control (AVC) function is turned OFF (in other words, value 0 is input), the procedure advances to step S17.

At step S16, the vehicle speed data value determined by referring to the table stored in the ROM 62 on the basis of the signal detected using the vehicle speed sensor 60 is stored in the RAM 64.

At step S18, in the case that the vehicle speed data value stored in the RAM 64 indicates that the traveling speed of the vehicle rises, adjustment is carried out so that the volume setting value set by the user is increased automatically. Furthermore, in the case that vehicle speed data value indicates that the traveling speed of the vehicle decreases, adjustment is carried out so that the volume setting value set by the user is decreased automatically. Hence, at step S18, the current volume setting value is the volume setting value set on the basis of the automatic volume control (AVC) function.

At step S14, in the case that the automatic volume control (AVC) function is turned OFF, the volume setting value set by the user is maintained as it is at step S17. Hence, at step S17, the current volume setting value is the volume setting value set by the user.

At step S20, a judgment is made as to whether the automatic tone control function is turned ON (in other words, AUTO is set). In the case that the automatic tone control function is turned ON, the procedure advances to step S22. Furthermore, in the case that the automatic tone control function is turned OFF (in other words, MANUAL is set), the procedure advances to step S25.

At step S22, the current volume setting value is the volume setting value set on the basis of the automatic volume control (AVC) function at step S18 or the volume setting value set by the user and maintained at step S17. In addition, the maximum allowable bass value and the maximum allowable treble value corresponding to the current volume setting value are respectively stored in the ROM 62 as shown in TABLE 1. Furthermore, at step S12, the bass setting value and the treble setting value set by the user are respectively stored in the RAM 64.

At step S22, a judgment is made as to whether the bass setting value and the treble setting value set by the user are larger than the maximum allowable bass value and the maximum allowable treble value, respectively. In the case that the bass setting value and the treble setting value set by the user are larger than the maximum allowable bass value and the maximum allowable treble value, respectively, the procedure advances to step S24. Furthermore, in the case that the bass setting value and the treble setting value set by the user are not more than the maximum allowable bass value and the maximum allowable treble value, respectively, the procedure advances to step S25.

At step S24, the bass setting value and the treble setting value set by the user are forcibly changed to the maximum allowable bass value and the maximum allowable treble value corresponding to the current volume setting value shown in TABLE 1, respectively, and stored respectively in the RAM 64. Hence, at step S24, the current bass setting value and the current treble setting value are the maximum allowable bass value and the maximum allowable treble value to which the values set by the user have been changed forcibly.

Moreover, at step S25, the bass setting value and the treble setting value set by the user are respectively maintained as they are. Hence, at step S25, the current bass setting value and the current treble setting value are the bass setting value and the treble setting value set by the user, respectively.

At step S26, the current bass setting value and the current treble setting value stored in the RAM 64 are the maximum allowable bass value and the maximum allowable treble value, respectively, to which the values set by the user have been changed forcibly at step S24, or the current bass setting value and the current treble setting value are the bass setting value and the treble setting value set by the user and maintained at step S25. Sound based on the current volume setting value described at step S22 and the current bass setting value and the current treble setting value described at step S26 is output from the speakers 28.

Then, at step S30, the sound distortion suppression control method executed sequentially is ended.

With the above-mentioned sound distortion suppression control method, even if sound is set by the user so as to have tone in which the bass or the treble is emphasized and sound distortion tends to occur, when the volume to be output is increased, the bass setting value and the treble setting value are only changed through software-based processing to the values (in other words, the maximum allowable bass value and the maximum allowable treble value) at which sound distortion is suppressed. Hence, the method has an effect capable of attaining sound distortion suppression control at low cost.

The configuration of the memory section (memory) for memorizing and storing various kinds of data and tables, such as the programs to be executed by the control section 52; default values (default volume value, default automatic volume control value and default bass value and default treble value) relating to default output sound; the table for calculating traveling speed of the vehicle on the basis of output data from the vehicle speed sensor 60; the volume setting value table for changing the volume setting value depending on the traveling speed of the vehicle on the basis of the setting mode or automatic volume control (AVC); and the table of predetermined data values (the maximum allowable bass value and the maximum allowable treble value) corresponding to each volume setting value and used to suppress sound distortion; and various values (the data value obtained from the vehicle speed sensor 60, the volume setting value, the bass setting value and the treble setting value for specifying sound to be output) relating to sound to be used when the programs are executed by the control section 52, is not limited to that of the above-mentioned embodiment. The configuration of the memory section (memory) can be implemented, for example, by singly using a flash memory that is a rewritable, nonvolatile semiconductor memory device wherein data is retained even when power supply is turned off, a magnetic recording medium, etc.

In the present invention, the bass (bass range) and/or the treble (treble range) in which sound distortion occurs are changed individually and independently. Hence, it is possible to change only the bass setting value or only the treble setting value or both the bass and treble setting values.

Furthermore, although the bass setting value and the treble setting value set by the user are changed to the maximum allowable bass value and the maximum allowable treble value, respectively, at step S24, the bass setting value and the treble setting value may be changed to a value smaller than the maximum allowable bass value and a value smaller than the maximum allowable treble value, respectively.

Moreover, although an example in which the acoustic control apparatus according to the present invention is mounted on the motor scooter 1 has been described as a preferable embodiment, the acoustic control apparatus according to the present invention is also applicable to convertible-type automobiles and motor tricycles.

1. A sound distortion suppression control method for suppressing the distortion of sound output from an acoustic apparatus mounted on a vehicle, comprising:
a step in which sound to be output is specified by a volume setting value, a bass setting value and a treble setting value, and said volume setting value, said bass setting value and said treble setting value are temporarily and respectively stored in a memory section,
a step in which a maximum allowable bass value and a maximum allowable treble value respectively corresponding to said volume setting value and used to suppress sound distortion are respectively stored in said memory section in advance,
a step in which in the case that said bass setting value and said treble setting value corresponding to the specified volume setting values become larger than said maximum allowable bass value and said maximum allowable treble value, respectively, said bass setting value and said treble setting value are changed to a value not more than said maximum allowable bass value and a value not more than said maximum allowable treble value, respectively, and
a step in which sound is output on the basis of said specified volume setting value, said changed bass setting value and said changed treble setting value.

2. The sound distortion suppression control method according to claim 1, wherein said volume setting value is controlled automatically depending on the traveling speed of the vehicle.

3. The sound distortion suppression control method according to claim 1, wherein the sound distortion of sound to be output is suppressed to a distortion ratio of not more than 1%.

4. An acoustic control apparatus for suppressing the sound distortion of sound to be output from an acoustic apparatus mounted on a vehicle, comprising:
a memory section for temporarily and respectively storing a volume setting value, a bass setting value and a treble setting value for specifying sound to be output and for respectively storing in advance a maximum allowable bass value and a maximum allowable treble value respectively corresponding to said volume setting value and used to suppress sound distortion, and
a control section for changing said bass setting value and said treble setting value to a value not more than said maximum allowable bass value and a value not more than said maximum allowable treble value, respectively, in the case that said bass setting value and said treble setting value respectively corresponding to the specified volume setting values become larger than said maximum allowable bass value and said maximum allowable treble value, respectively, wherein
sound is output on the basis of said specified volume setting values, said changed bass setting value and said changed treble setting value.

5. The acoustic control apparatus according to claim 4, wherein said volume setting value is adjusted automatically depending on the traveling speed of the vehicle.

6. The acoustic control apparatus according to claim 4, wherein the sound distortion of sound to be output is suppressed to a distortion ratio of not more than 1%.
